(19) United States
(12) Patent Application Publication
(10) Pub. No.: US 2013/0319374 A1
(43) Pub. Date: Dec. 5, 2013

(54) Injection Device for a Fluid

(71) Applicants: Harald Schmidt, Wien (AT); Richard Pirkl, Bulle (CH)

(72) Inventors: Harald Schmidt, Wien (AT); Richard Pirkl, Bulle (CH)

(73) Assignee: Liebherr Machines Bulle SA, Bulle (CH)

(21) Appl. No.: 13/984,222

(22) PCT Filed: Feb. 8, 2012
(86) PCT No.: PCT/EP12/00580

§ 371 Date: Aug. 7, 2013

(30) Foreign Application Priority Data
Feb. 8, 2011 (CH) 00231/11

(51) Int. Cl. F02M 61/16

(52) U.S. Cl. CPC F02M 61/161
USPC 123/456; 239/585.1; 239/5

(57) ABSTRACT

An injection device for a fluid, in particular for fuel, with has at least one electric and/or electronic control element, at least one valve, at least one first throttle, and a second throttle. The valve can be switched into at least one first throttle position by activating the first throttle and into at least one second throttle position by activating the second throttle. The valve is directly and/or indirectly coupled with the control element such that, by way of an actuating operation of the control element directly and/or indirectly, the valve can be switched from the first into the second throttle position and/or vice versa. Furthermore, the present invention relates to a common-rail injection system, an internal combustion engine, a motor vehicle, a ship, and a method for injecting a fluid.

The present invention relates to an injection device for a fluid, in particular for fuel, and to a common-rail injection system, an internal combustion engine, a motor vehicle, a ship as well as a method for injecting a fluid.

The common-rail injection, which also is referred to as accumulator injection, relates to injection systems for internal combustion engines, in which a high-pressure pump brings the fuel to a high pressure level. The pressurized fuel fills a pipe system which in operation of the engine constantly is under pressure. In common-rail injection systems, there is used a common high-pressure fuel accumulator (common rail) with corresponding outlets for supplying the cylinders with fuel.

FIG. 10 shows a common-rail injection system known from the prior art with an injection device 10′ in which a needle 12 loaded with a spring 14 can block and clear the outlet to at least one injection hole 18, which also can have the function of a throttle 18. Via the high-pressure pump 70, fuel from the tank 60 is pumped into the rail accumulator 80 and kept there under high pressure. The tank 60 is connected with the high-pressure pump 70 via the line 62.

The valve 27′ can be actuated via the engine controller 20, also referred to as ECU 20, and via the magnet 25 or solenoid switch 25. The valve 27′ is a 2/2-way valve and in the position shown in FIG. 10 blocks the return line 64 which leads from the injection device 10′ or the control space 11 of the injection device 10′ to the tank 60. In the return line 64, the outflow throttle 50′ is arranged downstream of the control space 11 and upstream of the valve 27′.

In the control space 11, stop elements 16′ are provided, against which the spring 12 can abut. Furthermore, the injection device 10′ includes a so-called injection space 13, into which the fuel fluid to be injected can get directly via the high-pressure pump 70 and the rail accumulator 80 via the lines 82 and 86. The control space 11 furthermore is connected with the rail accumulator 80 via the lines 82 and 84, in which an inflow throttle 40′ is arranged.

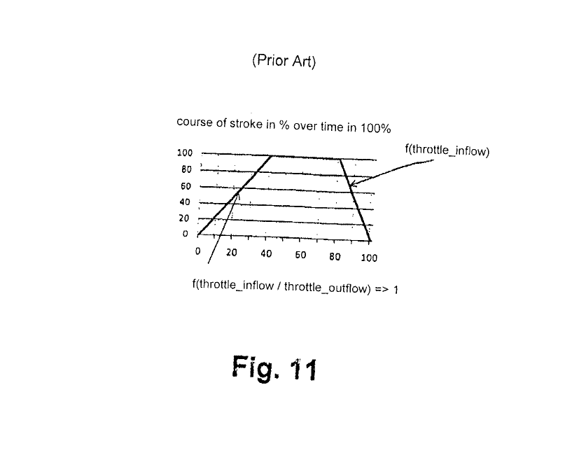

In connection with FIG. 10 and FIG. 11, the injection process will now be explained by way of example. FIG. 11 shows the course of the stroke in percent [%] in dependence on the time, which likewise is plotted in percent [%], wherein 100% correspond to the time of an injection process. FIG. 11 thus shows the rising ramp and the descending flank of the injection rate of the injection device 10′.

On opening of the valve 27′ by means of the ECU 20 and by means of the magnet 25, the needle 12 can be moved back in direction of the stop 16′ and in doing so works against the force of the spring 14. This will happen as long as the valve 27′ is open, wherein the needle 12 has reached the stop 16′ at the end of the rising ramp at the time t=40% as shown in FIG. 11. The stroke length then is 100%. During this time, a maximum injection is effected via the injection hole 18. The time t=80% as shown in FIG. 11 is the moment in which the 2/2-way valve 27′ is transferred into the closed position by means of the ECU 20 and via the magnet 25 and the closing operation is started, so that due to the build-up of pressure in the control space 11 the needle 12 is again transferred into the closed position.

This common-rail system shown in FIGS. 10 and 11, however, has the disadvantage that it does not provide for an independent rising ramp and descending flank of the injection rate. In addition, quantity variances can occur during the injection process. Although a fast closing and slower opening movement of the nozzle needle is possible, this is only achieved via the additional throttle 40′ and the control space 11. The tightness of these components influences the switching operation and therefore is subject to high variances.

In the remaining, presently available common-rail injection systems, there also exists a dependence of the rising flank on the relation of the throttles and hence is not freely selectable. Also with regard to the improvement of emission values it would be desirable, however, to provide for a further improvement of the combustion quality for example in diesel engines, but also in gasoline engines with direct injection, in that the injection process can be carried out even more exactly.

Therefore, it is the object of the present invention to develop an injection device as mentioned above in an advantageous way, in particular to the effect that the same provides for an independent rising ramp and descending flank of the injection rate.

According to the invention, this object is solved by an injection device with the features of claim 1. Accordingly, it is provided that an injection device for a fluid, in particular for fuel, is provided with at least one electric and/or electronic control element, with at least one valve, with at least one first throttle and with at least one second throttle, wherein the valve can be switched into at least one first throttle position by activating the first throttle and into at least one second throttle position by activating the second throttle, wherein the valve is directly and/or indirectly coupled with the control element such that by means of an actuating operation of the control element directly and/or indirectly the valve can be switched from the first into the second throttle position and/or vice versa.

The fluid, in particular fuel, for example can be diesel fuel or gasoline. The injection device in particular can be an injection device for diesel engines or gasoline engines with direct injection. The injection device can include a spring-loaded needle by means of which the outflow to an outflow throttle or an injection nozzle can be closed and/or cleared.

The at least one electric and/or electronic control element can be an electrically and/or electronically actuatable control element. In particular, the control element can be a suitable actuator, by means of which the valve correspondingly can be actuated in a suitable way.

In the at least one first throttle position it can be provided that the valve clears a corresponding feed line of the first throttle, so that the fluid can flow through this throttle. The same applies for the second throttle position, in which the valve is switched such that a feed line to the second throttle is cleared such that the fluid can flow through the second throttle.

By means of a corresponding actuation, the valve then can be switched from the first into the second throttle position and/or vice versa, or the valve advantageously is switchable from the first into the second throttle position and/or vice versa. In particular, in the first throttle position it is provided that there is no flow through the second throttle, and in the second throttle position it is furthermore provided in particular that there is no flow through the first throttle.

Such injection device has the advantage that only a small leakage occurs and such leakage only occurs during the switching operation of the injection device: Furthermore, the throttles for the injection device are selectable independently. In particular, it is possible to independently select the throttles for needle closing of the injection device and for needle opening of the injection device, when the injection device includes corresponding needles for the fluid dosage of the injection process. Moreover, it is no longer necessary now to have the opening e.g. of these needles take place as a result of the relation of the throttles. This dependence advantageously is overcome. In addition, it is no longer necessary now to define the closing of the needles only by a corresponding inflow throttle and the design of the needle spring.

Rather, it now is possible to provide for an independent rising ramp and descending flank of the injection rate. Due to the simple switching by means of the control element, a throttle responsible for the rising ramp can be switched over to the responsible throttle for the descending flank. Hence it is possible to provide the throttles optimally dimensioned for the respective task. Such injection device allows to manage with extremely small forces. Corresponding actuating elements therefore can be provided easily and reliably.

Furthermore, it is provided that the first throttle position is a throttle position for the adjustment of a descending flank of the fluid injection and/or that the second throttle position is a throttle position for the adjustment of a rising ramp for the fluid injection and/or that the first throttle is an inflow throttle by means of which at least the descending flank of the fluid injection is adjustable and/or that the second throttle is an outflow throttle by means of which at least the rising ramp for the fluid injection is adjustable. In particular, it can be provided that in the first throttle position the first throttle is cleared, so that the descending flank of the fluid injection is obtained. The ascent or descent and hence the length of time of the descending flank decisively is determined by the configuration of the first throttle. Furthermore, it can be provided in particular that in the second throttle position the second throttle is cleared, so that the rising ramp of the fluid injection is obtained. The ascent and hence the length of time of the rising ramp decisively is determined by the configuration of the second throttle.

Furthermore, it is conceivable that the valve includes at least one high-pressure sealant.

In addition, it can be provided that the positioning means can be controlled and/or regulated directly and/or indirectly via a control and/or regulating means, in particular an ECU.

Furthermore, it can be provided that at least one 2/2-way valve is provided, which is connectable and/or connected with a connecting line for the fluid, in particular a return line to a fluid tank.

Furthermore it is possible that at least one lever means and/or a connector means is provided, by means of which the valve can be actuated, in particular in a pressing and/or pulling manner. The lever means in particular can be a simple lever and the connector means in particular can be a simple connector such as a linearly movable rod capable of absorbing tensile and compressive forces or a linearly movable bar capable of absorbing tensile and compressive forces.

In addition it is possible that the control element is and/or comprises at least one magnet means and/or at least one piezo element. It is also possible advantageously to provide for closing for example of the needle of an injection device, but also for a corresponding switching to an opening of the needle directly via the coupling by means of a magnet. The magnet means can be a corresponding magnet or solenoid switch.

In addition, it is conceivable that by means of the magnet means the 2/2-way valve and the valve can be actuated, in particular at the same time, wherein it preferably is provided that the valve can be actuated directly via the lever means.

Furthermore, it can be provided that at least one throttle is arranged in a bypass line.

Advantageously, it is provided that the injection device is part of a common-rail injection system.

Furthermore, the present invention relates to a common-rail injection system with the features of claim 10. Accordingly, it is provided that a common-rail injection system is provided with at least one injection device according to any of claims 1 to 9 or includes at least one injection device according to any of claims 1 to 9.

Furthermore, the present invention relates to an internal combustion engine with the features of claim 11. Accordingly, it is provided that an internal combustion engine is provided with at least one injection device according to any of claims 1 to 9 and/or with at least one common-rail injection system according to claim 10.

Furthermore, the present invention relates to a motor vehicle with the features of claim 12. Accordingly, it is provided that a motor vehicle, in particular a passenger car or a truck, is provided with at least one injection device according to any of claims 1 to 9 and/or with at least one common-rail injection system according to claim 10 and/or with at least one internal combustion engine according to claim 11.

In addition, the present invention relates to a ship with the features of claim 13. Accordingly, it is provided that a ship is provided with at least one injection device according to any of claims 1 to 9 and/or with at least one common-rail injection system according to claim 10 and/or with at least one internal combustion engine according to claim 11.

In addition, the present invention relates to a method with the features of claim 14. Accordingly, it is provided that in a method for injecting fluid by means of an injection device with at least one valve, with at least one first throttle and with at least one second throttle the valve is switched from at least one first throttle position by activating the first throttle into at least one second throttle position by activating the second throttle and/or vice versa.

Advantageously, it is provided that the method is carried out by using an injection device according to any of claims 1 to 9.

Further details and advantages of the invention will now be explained in detail with reference to an exemplary embodiment illustrated in the drawing.

In the drawing:

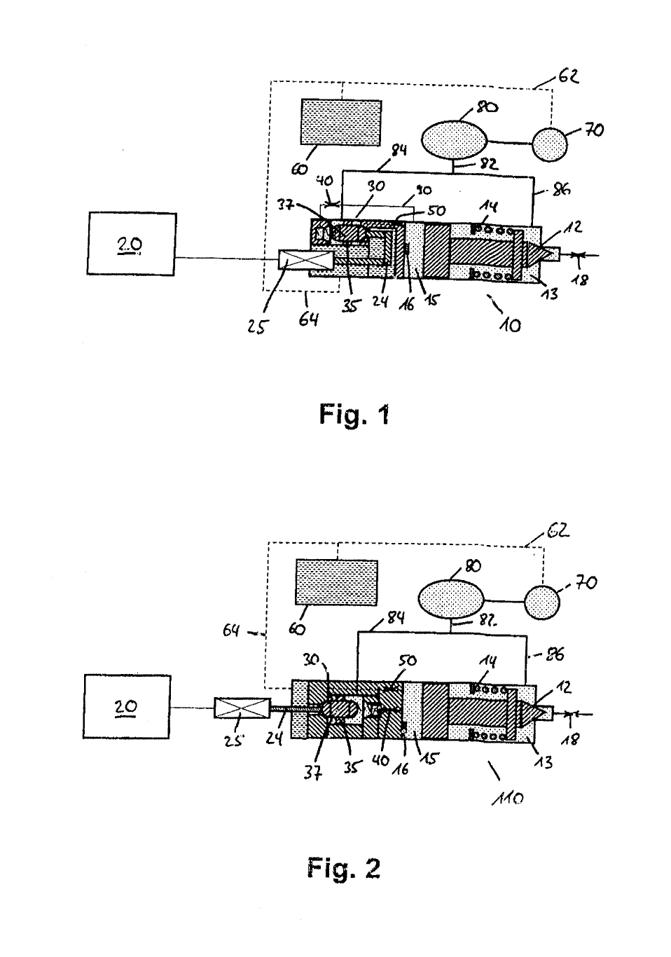

FIG. 1: shows an injection device of a common-rail system according to the invention in a schematic representation according to a first embodiment;

FIG. 2: shows an injection device of a common-rail system according to the invention in a schematic representation according to a second embodiment;

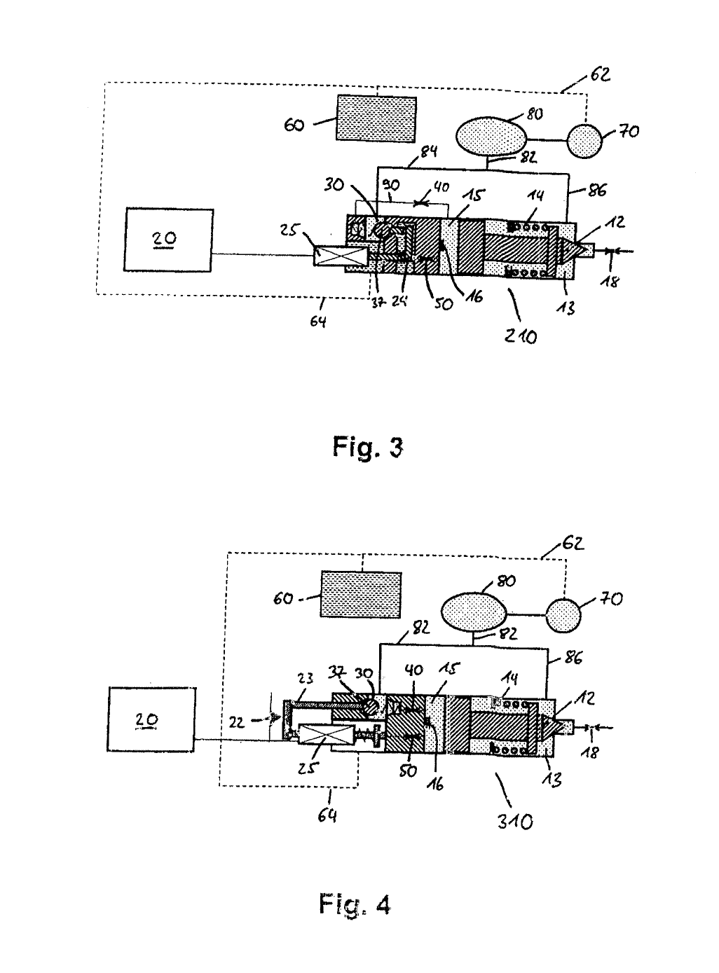

FIG. 3: shows an injection device of a common-rail system according to the invention in a schematic representation according to a third embodiment;

FIG. 4: shows an injection device of a common-rail system according to the invention in a schematic representation according to a fourth embodiment;

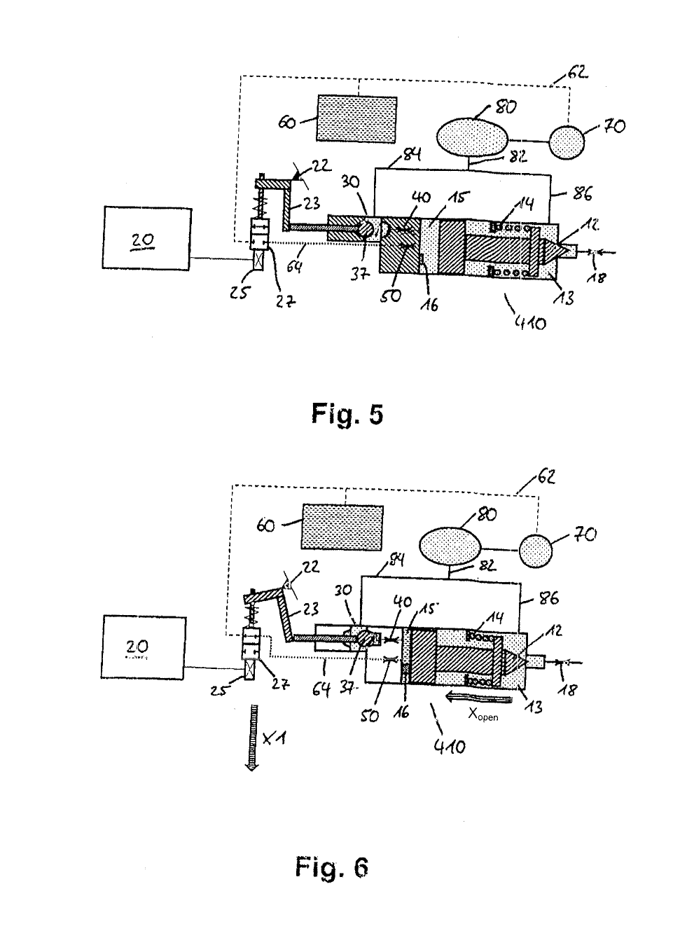

FIG. 5: shows an injection device of a common-rail system according to the invention in a schematic representation according to a fifth embodiment;

FIG. 6: shows a schematic representation of the embodiment shown in FIG. 5 in a first switching position in a schematic representation;

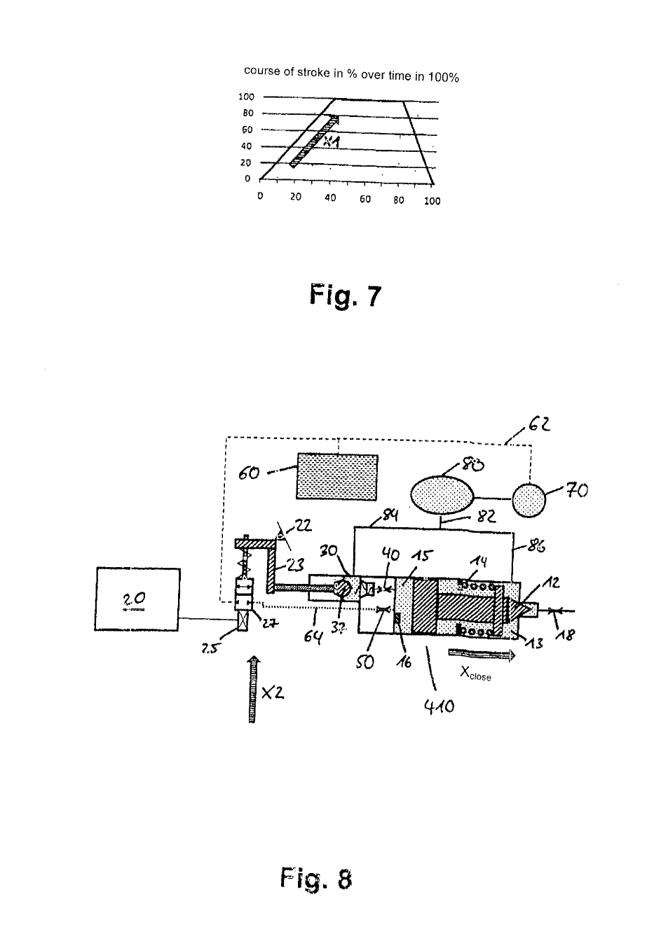

FIG. 7: shows a diagram of the course of the stroke in percent concerning the switching position shown in FIG. 6;

FIG. 8: shows a schematic representation of the embodiment shown in FIGS. 5 and 6 in a second switching position;

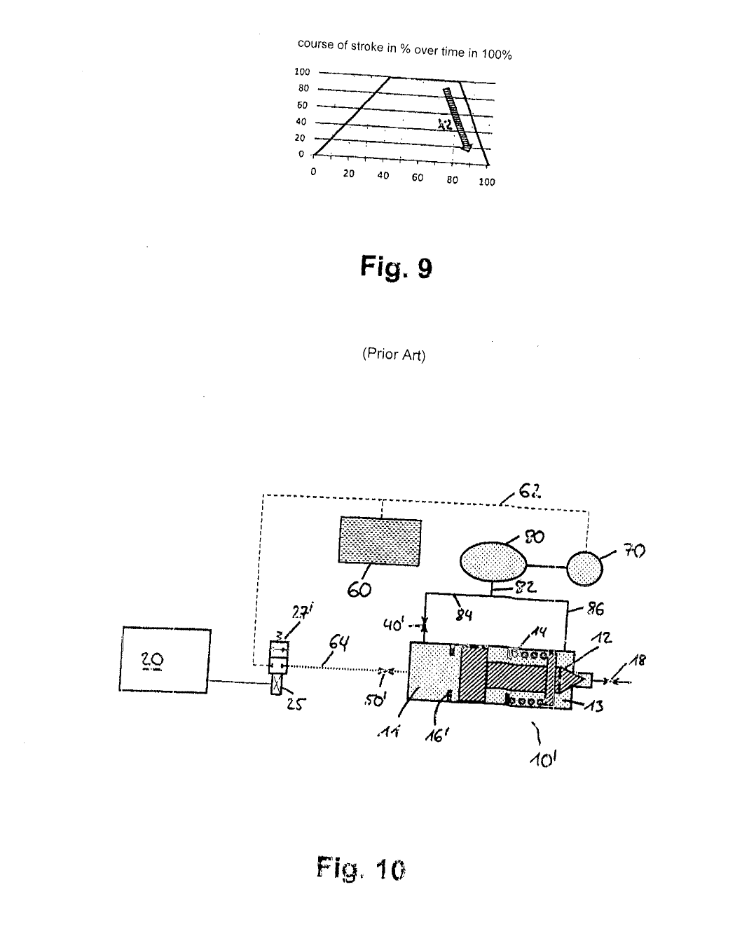

FIG. 9: shows a diagram of the course of the stroke in percent concerning the switching position shown in FIG. 8;

FIG. 10: shows a schematic representation of a known common-rail injection system; and

FIG. 11: shows a diagram of the course of the stroke in percent concerning the switching position shown in FIG. 10.

FIG. 1 shows a common-rail injection system according to the invention with an injection device 10 according to the invention, which is a design with a connector 24 with a guidance of the valve body of the valve 30 as change-over switch. Comparable features, which were described already in connection with the common-rail system from the prior art as shown in FIG. 10, are provided with the same reference numerals, wherein in FIG. 10 comparable components and features partly are provided with primed reference numerals for better distinction.

The control element 25, here a magnet 25 in pressing standard design, is switched on at a specified time via the ECU 20 and carries along the valve body 37 of the valve 30 coupled directly via the connector 24. As a result, the low-pressure side valve surface of the valve 30 is cleared. The high-pressure space 15 of the nozzle needle 12 is connected via the outflow throttle 50 for the outflow thereof, and the liquid now can flow off due to the opening of the valve body 37 of the valve 30. The nozzle needle 12 is lifted corresponding to the chosen throttle with a mostly small velocity, in order to obtain an e.g. gently rising injection rate.

The fast moving magnet 25 is stopped at the end of its stroke, and due to the formation of a further valve seat, the inflow to the high-pressure space 15 of the nozzle needle is stopped.

The same is equipped with a further throttle 40 in the inflow and thus prevents closing of the needle 12. When the magnet 25 now is switched off, the same moves into its starting position and closes the low-pressure bore. Via the throttle 40, the high-pressure space 15 hence is connected with the inflow 84 of the high-pressure line and corresponding to the chosen throttle 40 the needle 12 closes very quickly in an advantageous design and the injection rate of the injection device 10 obtains the desired property.

The throttle 40 is arranged in a bypass line 90, whereas the outflow throttle 50 is arranged in the interior of the injection device 10. The valve 30 has a valve body 37, which in the design shown here in addition is provided with a high-pressure seal 35 or is guided in a high-pressure seal 35.

In the embodiment shown in FIG. 1, the connector 24 has a U-shaped design and can transfer the valve 30 into the first or second throttle position by corresponding actuation, in particular pulling actuation, by means of the magnet 25.

In FIGS. 2 to 9 further exemplary embodiments of the injection devices 10, 110, 210, 310 and 410 according to the invention are shown, wherein the same or comparable features are provided with the same reference numerals.

FIG. 2 shows an injection device 110 in a further embodiment, wherein the embodiment shown in FIG. 2 likewise is a design with a connector 24. In contrast to the embodiment shown in FIG. 1, the connector 24 is formed rod-shaped and the inflow throttle 50 likewise is arranged in the interior of the injection device 110. The connector 24 is able to transfer into the first and second throttle position, respectively, in particular by pressing actuation of the valve 30.

FIG. 3 shows a further embodiment with an injection device 210, in which comparable to FIG. 1 a connector 24, which here is L-shaped, is provided for the pulling actuation of the valve 30. The valve 30 has a ball-shaped valve body 37. The inflow throttle 40 here likewise is arranged in a bypass line 90.

FIG. 4 shows a further embodiment of the injection device 310, in which the magnet 25 actuates a lever 23 arranged outside or partly outside the injection device 310, which is supported by means of a bearing 22. In the second throttle position, the valve 30 with a ball-shaped valve body 37 is able clear the inflow throttle 40 and block the same in the first throttle position.

In the further embodiment of the injection device 410 as shown in FIG. 5, a directly controlled switching of the throttles is effected. There is likewise provided a lever 23, which is supported by means of a bearing 22. FIG. 5 shows the position in which the magnet 25 is switched off. Consequently, no fluid can flow off via the outflow throttle 50 and the discharge line 64, since the valve 27 correspondingly blocks the discharge line 64. The valve 30 is in the first throttle position, so that via the feed line 84 and via the throttle 40 the high-pressure space 50 is pressurized by the fluid stream such that the needle 12 closes the inflow to the throttle 18.

FIG. 6 now shows the condition in which the magnet 25 is switched on, so that a movement is effected in direction X1, whereby the lever 23 moves the valve body 37 of the valve 30 into the second throttle position, so that the throttle 40 is blocked. At the same time, the valve 27 is switched such that fluid can flow off from the high-pressure space 15 via the discharge line 64 and via the throttle 50. As a result, the valve opens the needle 12. Then, fuel can flow from the rail accumulator 80 via the lines 82 and 86 through the injection space 13, leave the injection device 410 via the throttle 18, and e.g. be injected into the corresponding cylinder of an internal combustion engine. The associated course of the stroke in percent [%] over the time in 100% is shown in FIG. 7.

FIG. 8 correspondingly shows the condition in which the magnet 25 is switched off, so that a movement is made in direction X2. By means of the lever 23 the valve body 37 of the valve 30 thereby is again transferred into the first throttle position, so that now fluid again flows into the high-pressure space 15 with high pressure via the line 84 and the throttle 40, whereas due to the closing of the valve 27 no fluid now can flow off from the high-pressure space 15 into the discharge line 64 via the throttle 50. The associated course of the stroke is shown in FIG. 9.

While in FIG. 6 the needle 12 has performed a movement in direction Xₒₚₑₙ, FIG. 8 now shows a correspondingly opposite movement in direction X_{close}.

1. An injection device for fuel, with comprising:
at least one electric and/or electronic control element,
at least one valve,
at least one first throttle, and
at least one second throttle,
wherein the valve can be switched into at least one first throttle position by activating the first throttle and into at least one second throttle position by activating the second throttle, and
wherein the valve is directly and/or indirectly coupled with the control element such that, by means of an actuating operation of the control element directly and/or indirectly, the valve can be switched from the first throttle position into the second throttle position and/or vice versa.

2. The injection device according to claim 1, wherein the first throttle position is a throttle position for the adjustment of a descending flank of the fluid injection and/or that the second throttle position is a throttle position for the adjustment of a rising ramp for the fluid injection and/or that the first throttle is an inflow throttle by means of which at least the descending flank of the fluid injection is adjustable and/or that the second throttle is an outflow throttle by means of which at least the rising ramp for the fluid injection is adjustable.

3. The injection device according to claim 1, wherein the valve includes at least one high-pressure sealant and/or the positioning means can be controlled and/or regulated directly and/or indirectly via an ECU.

4. The injection device according to claim 1, further comprising at least one 2/2-way valve that is connectable and/or connected with a connecting line for the fluid forming a return line to a fluid tank.

5. The injection device according to claim 4, further comprising at least one lever means and/or connector means by which the valve can be actuated in a pressing and/or pulling manner.

6. The injection device according to claim 5, wherein the control element is or comprises at least one magnet means and/or at least one piezo element.

7. The injection device according to claim 6, wherein, by means of the magnet means, the 2/2-way valve and the at least one valve can be actuated at the same time, and wherein the at least one valve can be actuated directly via the lever means.

8. The injection device according to claim 1, wherein at least one throttle is arranged in a bypass line.

9. The injection device according to claim 1, wherein the injection device is part of a common-rail injection system.

10. A common-rail injection system comprising at least one injection device according to claim 1.

11. An internal combustion engine comprising at least one injection device according to claim 1.

12. A passenger car or truck comprising at least one injection device according to claim 1.

13. A ship comprising at least one injection device according to claim 1.

14. A method for injecting fluid by means of an injection device with at least one valve, with at least one first throttle, and with at least one second throttle, comprising switching the valve from at least one first throttle position by activating the first throttle into at least one second throttle position by activating the second throttle and/or vice versa.

15. The method according to claim 14, wherein the method is carried out by using an injection device comprising:
at least one electric and/or electronic control element,
at least one valve,
at least one first throttle, and
at least one second throttle,
wherein the valve can be switched into at least one first throttle position by activating the first throttle and into at least one second throttle position by activating the second throttle, and
wherein the valve is directly and/or indirectly coupled with the control element such that, by means of an actuating operation of the control element directly and/or indirectly, the valve can be switched from the first throttle position into the second throttle position and/or vice versa.
